(19) United States
(12) Patent Application Publication
(10) Pub. No.: US 2019/0171956 A1
(43) Pub. Date: Jun. 6, 2019

(54) VERIFICATION SYSTEM, VERIFICATION METHOD, AND RECORDING MEDIUM FOR STORING VERIFICATION PROGRAM

(71) Applicant: NEC Corporation, Minato-ku, Tokyo (JP)

(72) Inventor: Kazuhiro FUNAKOSHI, Tokyo (JP)

(73) Assignee: NEC Corporation, Minato-ku, Tokyo (JP)

(21) Appl. No.: 16/095,731

(22) PCT Filed: Apr. 17, 2017
(86) PCT No.: PCT/JP2017/015427

§ 371 Date: Oct. 23, 2018

(30) Foreign Application Priority Data
Apr. 28, 2016 (JP) 2016-090233

(51) Int. Cl. G06N 7/00; G06N 5/04

(52) U.S. Cl. CPC G06N 7/00; G06N 5/045

(57) ABSTRACT

A verification system includes at least one memory configured to store instructions; and at least one processor configured to execute the instructions to: receive, as input, a mathematical model obtained by converting a model indicating a configuration of a test object system into a predicate in predicate logic and create a proposition indicating that the test object system satisfies a performance requirement represented by the predicate; and verify whether or not a proof of the proposition having been created is true.

### TECHNICAL FIELD

The present invention relates to a verification system or the like that verifies a non-functional requirement of a system.

### BACKGROUND ART

There is a system in which a control process is performed after measuring information in a real world environment by a sensor (sensing) and performing a calculation process on data obtained through the sensing. When a result of control performed by the system has a large influence, a designer is required to carefully perform design, development, and verification of the system.

In general, a system requirement is categorized into a functional requirement and a non-functional requirement. The functional requirement is a requirement related to a function among requirements defined in information system development or software development. The functional requirement includes requirements related to type of data to be treated or structure, processing content, screen display format, operation method, output format of a form or the like, and the like.

The non-functional requirement is a general requirement other than the functional requirement among requirements defined in information system development or software development. The non-functional requirement includes requirements related to performance, reliability, scalability, operability, security, and the like. A simulation technology using a queue is often used for determining whether or not the non-functional requirement is satisfied.

A system designer is required to predict the load on a calculation process to information inputted to the system in advance. The load on the calculation process depends on an event generation timing or an amount of data to be processed.

However, at the time of system design, it is difficult for the designer to predict the event generation timing or the amount of data to be processed. In other words, it is difficult for the designer to predict the load on the calculation process at the time of system design.

Hereinafter, “the load is applied to the system” is represented as “the load arrives to the system”. Because it is difficult to predict the load caused by the event which occurs in a real world, for example, a method in which a distribution of the load which arrives to the system is created and it is determined whether or not the non-functional requirement is satisfied by using the created distribution is adopted as an alternative method.

Even when by using the above-mentioned alternative method, it is determined that the non-functional requirement is satisfied, there is a possibility that the load deviated from the created distribution does not satisfy a predetermined non-functional requirement. When the system having the non-functional requirement of which there is a possibility that the load which does not satisfy the predetermined non-functional requirement exists is used, an incident that has an influence on the real world may occur.

Further, in queuing theory, a distribution represented by a function which can be analytically solved is known. When the distribution represented by the function which can be analytically solved is used, a system designer can analytically solve a problem of whether or not the non-functional requirement is satisfied.

When the distribution represented by a function which cannot be easily and analytically solved is used, the system designer samples an arrival load that is a load which arrives to the system by, for example, the Monte Carlo method or the like. Next, the designer performs a simulation to a sampling result and statistically estimates system performance to a whole arrival load. Further, in this description, an operation to apply one value to a function is called sampling and a calculation process is called simulation.

Even when a system configuration is determined by the above-mentioned method, the system performance is only statistically estimated. Therefore, the system performance to the arrival load that is not sampled is not guaranteed completely.

For example, a case in which a mean value of sin(x) whose domain is x=[0, π] is calculated by simulation is considered. As a method for calculating a mean value, there is a method in which sin(x) is calculated while increasing x from x=0 to x=π with a step size of 0.01 and the mean value of a calculation result is calculated.

However, as mentioned above, when the step size is 0.01, the correct mean value of sin(x) cannot be calculated. In order to calculate the correct mean value, it is necessary to make the step size infinitely small.

On the other hand, when the infinitely small step size is used, the number of times of calculation increases to infinite and the simulation cannot be carried out. In other words, the number of values that can be taken by a variable is infinite but the simulation is performed to one value. Therefore, in principle, it is impossible to perform the simulation to all the values that can be taken by the variable included in a function.

### CITATION LIST

### Patent Literature

[Patent Literature 1] Japanese Patent Publication No. 5843230

### SUMMARY OF INVENTION

### Technical Problem

As described above, when the distribution of loads which arrive to the system is represented by a function which cannot be analytically solved, only the statistically estimated performance is guaranteed when using the known method. It is difficult, by using the known method, to exhaustively guarantee the performance of the system in which a change caused by the change in environment of the load that arrives to the system is large.

Further, when considering that the arrival load deviated from the distribution exists at a predetermined rate, the system whose performance is highly exhaustively guaranteed can be designed by verifying whether or not the system performance is guaranteed to a probability of the load that arrives to the system.

In order to exhaustively guarantee the system performance, it is necessary to solve a problem of whether or not the system performance is guaranteed by a mathematical method by using the distribution of the arrival load represented by a mathematical model which can be analytically solved.

However, it is difficult for a designer that is not an expert of mathematics to describe the mathematical model to be used by the mathematical method. This is because background knowledge of mathematics is required to create the mathematical model.

In patent literature 1, a method for verifying a hybrid system and a method for converting a model of a hybrid system are described. In the verification method described in patent literature 1, it is verified whether or not the hybrid system operates as designed.

In the verification method described in patent literature 1, a model in which an operation of the hybrid system is coded by using a programming language is created, a logical formula indicating a verification condition of a code of the model is created, and the code of the model is verified by proving the created logical formula by a theorem prover. In other words, in the verification method described in patent literature 1, a problem of whether or not the operation of the hybrid system is guaranteed is solved by the mathematical method.

However, the hybrid system described in patent literature 1 is a system that operates while a continuous value and a discrete value are influencing each other. In other words, in the verification method described in patent literature 1, a probability is not assumed as an object to be inputted.

In order to mathematically confirm whether or not the performance is guaranteed with respect to the probability of the load that arrives, for example, a method in which a performance requirement is represented by a predicate in a predicate logic described later may be used. This is because the performance requirement can be represented by the predicate so as to correspond to the load with probability.

Further, in the verification method described in patent literature 1, it is not assumed that the mathematical model is created on the basis of a content described in Systems Modeling Language (SysML).

### OBJECT OF INVENTION

Accordingly, an object of the present invention is to provide a verification system and the like that resolve the above-mentioned issue and mathematically prove that the system performance is guaranteed with respect to probability of a load that arrives.

### Solution to Problem

One aspect of a verification system according to the present invention includes: creation means for receiving, as input, a mathematical model obtained by converting a model indicating a configuration of a test object system into a predicate in predicate logic and creating a proposition indicating that the test object system satisfies a performance requirement represented by the predicate; and verification means for verifying whether or not a proof of the proposition having been created is true.

One aspect of a verification method according to the present invention includes: inputting a mathematical model obtained by converting a model indicating a configuration of a test object system into a predicate in predicate logic and creating a proposition indicating that the test object system satisfies a performance requirement represented by the predicate; and verifying whether or not a proof of the proposition having been created is true.

One aspect of a recording medium storing a verification program according to the present invention. The verification program causes a computer to: input a mathematical model obtained by converting a model indicating a configuration of a test object system into a predicate in predicate logic, create a proposition indicating that the test object system satisfies a performance requirement represented by the predicate, and verify whether or not a proof of the proposition having been created is true.

### Advantageous Effects of Invention

The present invention enables to prove mathematically that the system performance is guaranteed with respect to probability of a load that arrives.

### BRIEF DESCRIPTION OF DRAWINGS

FIG. 1 is a block diagram illustrating an example of a configuration of a verification system 100 according to a first example embodiment.

FIG. 2 is a flowchart illustrating operation of a verification process performed by a verification system 100 according to the present example embodiment.

FIG. 3 is a block diagram illustrating an example of a configuration of a verification system 100 according to a second example embodiment.

FIG. 4 is a flowchart illustrating operation of a verification process performed by a verification system 100 according to the second example embodiment.

FIG. 5 is an activity diagram representing a system model of a verification object.

FIG. 6 is a block diagram illustrating an outline of a verification system of the present invention.

### EXAMPLE EMBODIMENT

### First Example Embodiment

[Description of Configuration]

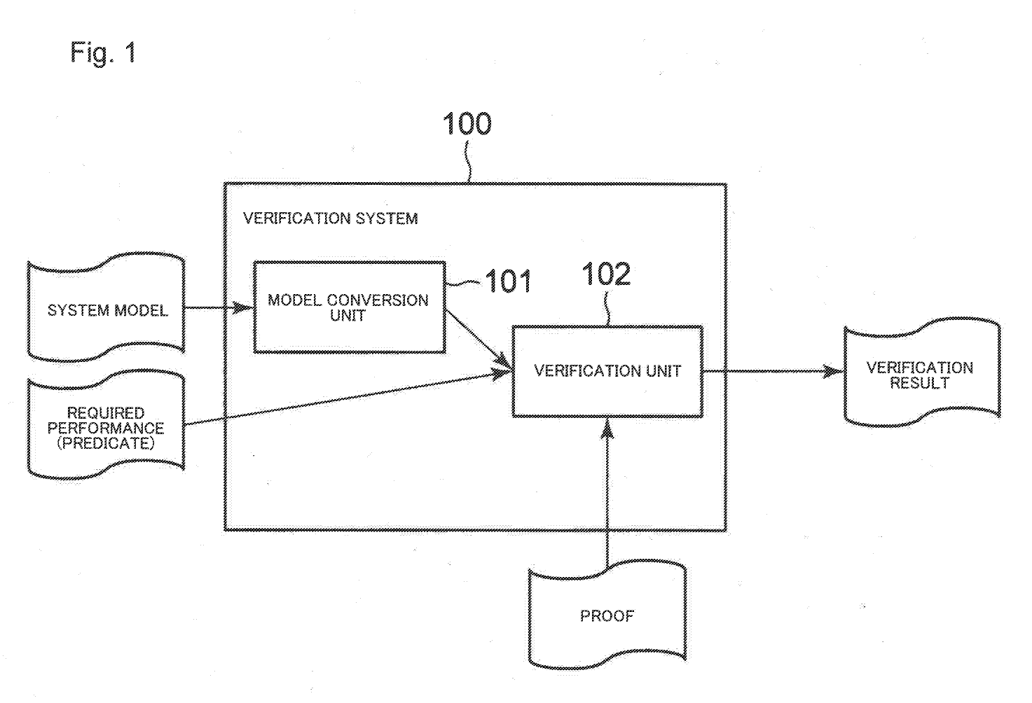

An example embodiment of the present invention will be described below with reference to the drawings. FIG. 1 is a block diagram illustrating an example of a configuration of a verification system 100 according to a first example embodiment. As shown in FIG. 1, the verification system 100 according to the present example embodiment includes a model conversion unit 101 and a verification unit 102.

The model conversion unit 101 has a function to create a load function on the basis of a system model. For example, an activity diagram in which the system model is described is inputted to the model conversion unit 101.

The activity diagram is a diagram indicating a transition of successive processes. In the activity diagram, the processes performed from the beginning to the end of a predetermined event are described in order of execution. The activity diagram is described in, for example, SysML.

Further, the activity diagram may be described in a language other than SysML. Further, the system model described in, for example, the markup language may be inputted to the model conversion unit 101.

The model conversion unit 101 creates the load function which returns information in which information about performance to the load in all the processes is integrated on the basis of an identifier of a component described in the activity diagram and a function which returns information about performance to the load in the process in each component. The created load function is a function which receives a time series of arrival load as input and returns a time series of performance.

The model conversion unit 101 creates the load function which can be verified from the activity diagram that can be easily handled. The created load function is a function that is an object to be tested by the verification unit 102.

The verification unit 102 has a function to verify whether or not the inputted proof is true. The verification unit 102 includes a theorem proof assistant tool (not shown). The verification unit 102 inputs the inputted proof to the theorem proof assistant tool and makes the theorem proof assistant tool verify whether or not the proof is true.

The created load function is inputted to the verification unit 102 from the model conversion unit 101. Further, a predicate representing a performance that is required (hereinafter, referred to as a required performance) is inputted to the verification unit 102. The verification unit 102 creates a proposition by applying the inputted load function to the inputted predicate.

Further, a content for proving the proposition that is the predicate representing the required performance to which the load function is given is inputted to the verification unit 102. The content of a proof is created by for example, a designer and inputted to the verification unit 102. Alternatively, the content for proving that the proposition does not hold may be inputted to the verification unit 102.

When the inputted proof is true, the verification unit 102 outputs a verification result indicating that the proof is true. Further, when the proof is wrong, the verification unit 102 outputs a verification result indicating that the proof is wrong.

Further, the predicate is a term in predicate logic that means a symbolic form system group in mathematical logic. For example, when property P of variable x is represented by “P(x)”, “P” corresponds to the predicate and “P(x)” corresponds to the proposition. Alternatively, x may not be the variable and be the proposition. In predicate logic, the proposition is a formula whose truth or falsity is uniquely determined. Furthermore, a formula which gives the variable included in the proposition later is the predicate on the variable.

In other words, in the present example embodiment, the required performance of an object to be tested is represented by the predicate in predicate logic. Further, in the present example embodiment, the predicate in first order predicate logic is used. However, the required performance may be represented by the predicate in higher-order predicate logic. Further, the predicate used in the present example embodiment is the predicate with which the probability distribution of the load is combined in advance.

The load function, the predicate representing the required performance of the object to be tested, and the created proof are inputted to the verification unit 102. For example, the verification unit 102 gives the inputted information to the theorem proof assistant tool and makes the theorem proof assistant tool determine whether or not the proof is true. Further, a component other than the theorem proof assistant tool included in the verification unit 102 may determine whether or not the proof is true.

[Description of Operation]

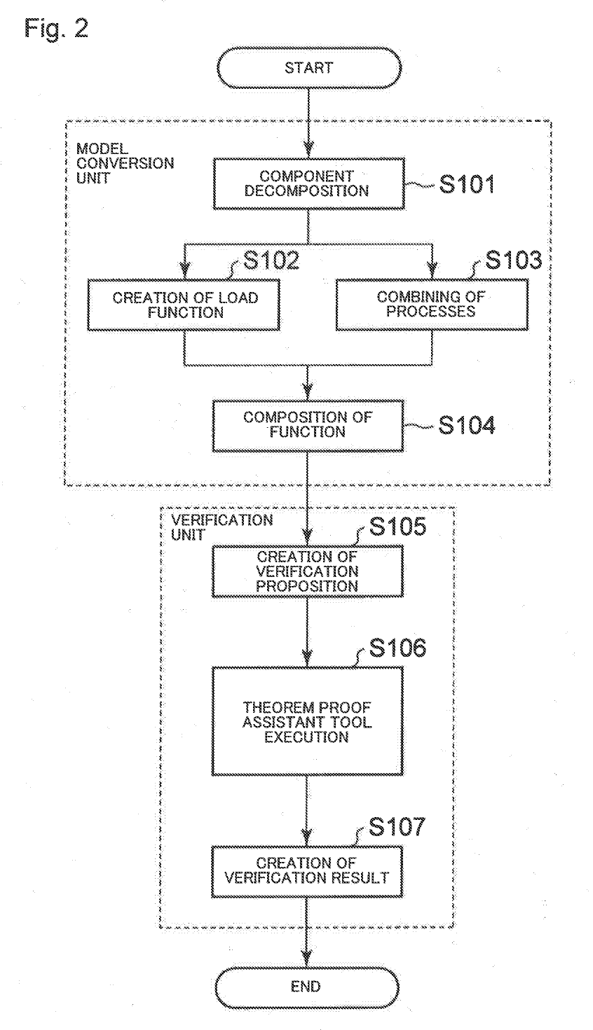

Operation to verify the proof that is performed by the verification system 100 according to the present example embodiment will be described below with reference to FIG. 2. FIG. 2 is a flowchart illustrating operation of a verification process performed by the verification system 100 according to the first example embodiment.

As shown in FIG. 2, the process from step S101 to step S104 is performed by the model conversion unit 101. First, the activity diagram is inputted to the model conversion unit 101.

The model conversion unit 101 performs component decomposition to the content indicated by the inputted activity diagram (step S101). By performing component decomposition, the model conversion unit 101 extracts information of the load in each process, an identifier of the process, and a relation of connection of processes.

Next, the model conversion unit 101 creates the load function on the basis of the information of the load in each process (step S102).

At the same time as the performance of the process of step S102, the model conversion unit 101 creates the load function with a placeholder by combining the placeholder of the load function, the identifier of the process, and each information indicating the relation of connection of processes (step S103). Further, the placeholder is a place temporarily reserved for the content to be inserted later.

Next, the model conversion unit 101 combines the load function created in step S102 with the load function with a placeholder created in step S103 (step S104). Specifically, the model conversion unit 101 creates the whole load function by applying the created load function to the placeholder of the load function with a placeholder.

As shown in FIG. 2, the process from step S105 to step S107 is performed by the verification unit 102. Next, the load function created in step S104 is inputted to the verification unit 102. The inputted load function is a function which receives a time series of load as input and returns a time series of performance.

Next, the verification unit 102 performs on the inputted load function a higher order process with respect to probability. When the higher order process is performed, the load function is converted into a function which receives a time series of the probability of load as input and returns a time series of the probability of performance.

For example, when time-series data represented as [1, 2, 3, 4, 5] is inputted to the load function to which the higher order process has not been performed as the time series of load, the load function returns time-series data represented as [1, 2, 3, 3, 3] as the time series of performance.

However, the time series of the probability of load that is an object to be processed in the present example embodiment is the time-series data such as [((0.5, 1), (0.5, 2)), . . . ] obtained by adding the probability to the time-series data of load represented as [1, 2, 3, 4, 5]. In the time series data of the probability of load, “0.5” is the probability.

For example, the verification unit 102 performs the higher order process with respect to probability by converting a structure of the inputted load function into a structure of a higher order map function in which calculation is executed on each probability branch. Here, the probability branch is a sequence of sets of a certain load and a probability at which the load is generated and means that an element in the sequence (the sequence of sets of a certain load and a probability at which the load is generated) is a load at a branch of each certain probability. For example, when 50 appears at a probability of one-half and 100 appears at a probability of one-half, the calculation process on the probability branch is a process in which a calculation to 50 and a calculation to 100 are performed at respective branch destinations.

The reason for the conversion into the structure of the function in which calculation is executed on the probability branch is because, for example, when a value which does not have the branch is inputted, it is necessary to perform only a process for calculating a single value from a single value. However, when a value which has the branch is inputted, it is necessary to perform each process for calculating the single value from each single value of the branch destination as mentioned above.

Next, the verification unit 102 creates the proposition of the verification object by applying the converted load function to the predicate representing the inputted required performance (step S105). Specifically, the verification unit 102 creates the proposition P(x) by inputting a load function x to the predicate P.

Next, the verification unit 102 sends the proposition of the verification object created in step S105 and the inputted proof to the theorem proof assistant tool. The verification unit 102 makes the theorem proof assistant tool verify whether or not the proof is true (step S106).

Next, the verification unit 102 generates information indicating a verification result on the basis of a response from the theorem proof assistant tool and outputs the generated information to outside (step S107). After outputting it, the verification system 100 finishes the verification process.

### Description of Advantageous Effects

In the verification system 100 according to the present example embodiment, in order to cope with load variation according to a probability distribution, the mathematical model that is the load function for which the higher order process is performed with respect to probability is used. When the higher order process is performed with respect to probability, the load function can be inputted to the predicate with which the probability distribution of the load is combined. Therefore, the verification unit 102 can exhaustively test the system performance to the probability of the load.

Further, the model conversion unit 101 of the verification system 100 according to the present example embodiment creates the load function of the verification object from the inputted activity diagram that can be easily used. Further, the verification unit 102 can create the proposition of the verification object by using the load function of the created verification object. Therefore, it is not necessary for the system designer to directly create the mathematical model that has to be prepared when using the theorem proof assistant tool and cannot be easily created.

### Second Example Embodiment

[Description of Configuration]

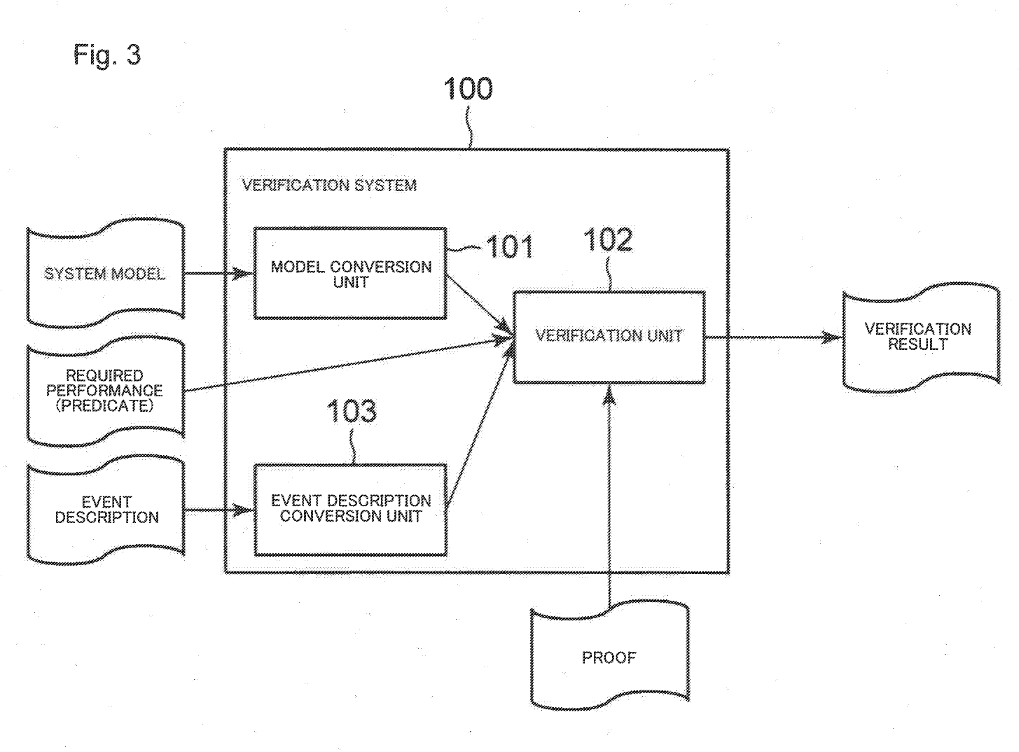

Next, a second example embodiment of the present invention will be described with reference to the drawings. FIG. 3 is a block diagram illustrating an example of a configuration of the verification system 100 according to the second example embodiment. As shown in FIG. 3, the verification system 100 according to the present example embodiment includes the model conversion unit 101, the verification unit 102, and an event description conversion unit 103. The configuration of the verification system 100 shown in FIG. 3 excluding the event description conversion unit 103 is similar to the configuration of the verification system 100 shown in FIG. 1.

An event description is inputted to the event description conversion unit 103. The event description conversion unit 103 has a function to convert the inputted event description into a time series of probabilities of arrival load.

The predicate representing the required performance combined with the time series of probabilities of arrival load that is created by the event description conversion unit 103 represents performance that is required to satisfy by the load function inputted to the verification unit 102 from the model conversion unit 101.

In the first example embodiment, the user designates the predicate representing the required performance with which the probability distribution of the predetermined arrival load is combined in advance. In the present example embodiment, the user can select the probability distribution to be combined with the predicate. Therefore, the verification unit 102 according to the present example embodiment is different from the verification unit 102 according to the first example embodiment and performs a process for combining the probability distribution of the arrival load with the predicate.

The verification unit 102 according to the present example embodiment also has the same function as the verification unit 102 according to the first example embodiment. In other words, the verification unit 102 can determine whether or not the system satisfies the predetermined performance requirement by verifying the proof of the proposition that is the predicate representing the required performance to which the load function is given by using the theorem proof assistant tool.

[Description of Operation]

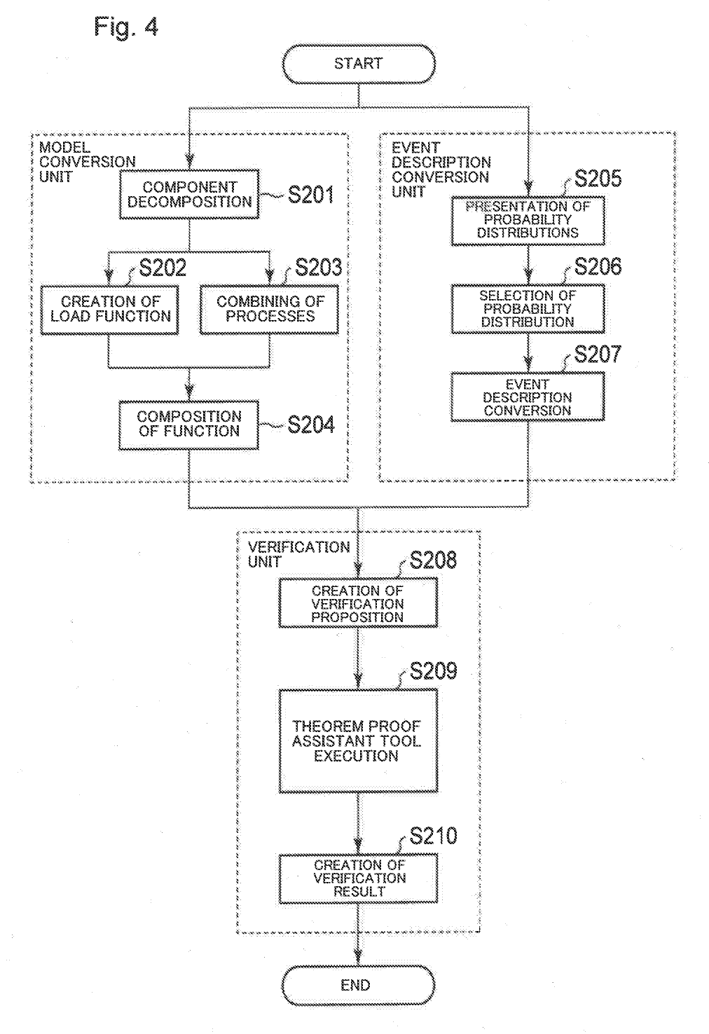

Operation to verify the proof of the verification system 100 according to the present example embodiment will be described below with reference to FIG. 4. FIG. 4 is a flowchart illustrating operation of the verification process performed by the verification system 100 according to the second example embodiment.

As shown in FIG. 4, the process from step S201 to step S204 is performed by the model conversion unit 101. The process from step S201 to step S204 is similar to the process from step S101 to step S104 in the first example embodiment.

Further, as shown in FIG. 4, the process from step S205 to step S207 is performed by the event description conversion unit 103.

First, the event description conversion unit 103 presents options of the probability distribution specified in advance to an operator (step S205).

Next, the operator designates one probability distribution among the options presented to select the probability distribution (step S206). Alternatively, the operator may select the probability distribution by adding the probability distribution designated in the event description.

Next, the event description conversion unit 103 converts the inputted event description into a time series of probabilities of arrival load by using the probability distribution selected in step S206 (step S207).

Further, when a plurality of the probability distributions are designated, the event description conversion unit 103 may convert the inputted event description into a time series of probabilities of arrival load by using the probability distribution obtained by combining the designated plurality of probability distributions.

Further, as shown in FIG. 4, the process from step S208 to step S210 is performed by the verification unit 102. The load function created in step S204 is inputted to the verification unit 102. The inputted load function is a function which receives the time series of load as input and returns the time series of performance.

Next, the verification unit 102 combines the time series of probabilities of arrival load that is obtained by the conversion in step S207 with the predicate representing the inputted required performance. Next, the verification unit 102 creates the proposition of the verification object by applying the inputted load function to the predicate representing the required performance that is obtained by the combination (step S208).

The process from step S209 to step S210 in the present example embodiment is similar to the process from step S106 to step S107 in the first example embodiment.

[Description of Advantageous Effects]

The verification system 100 according to the present example embodiment has an effect that the predicate representing the required performance prepared by the operator can be more easily described, in addition to the effect obtained in the first example embodiment. This is because typical probability distributions are specified in advance, the operator only selects one probability distribution among the specified probability distributions, and the verification unit 102 combines the time series of probabilities of arrival load with the predicate representing the required performance.

In other words, the operator can prepare the predicate representing the required performance with which the probability distribution of the arrival load is not combined. Further, because the probability distribution can be designated, when the verification system 100 according to the present example embodiment is used, the convenience for the user is further improved.

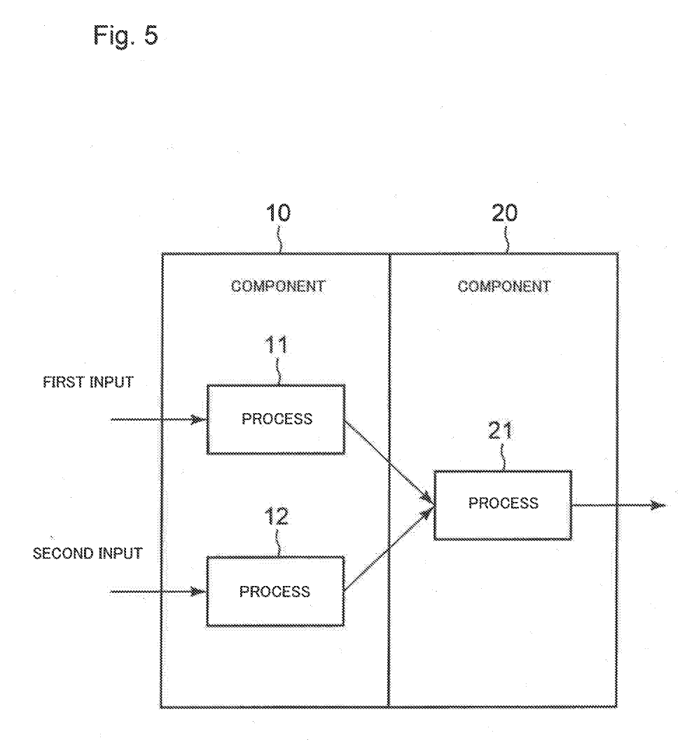

A specific example of an example embodiment will be described below with reference to the drawing. FIG. 5 is the activity diagram illustrating the system model of the verification object. The system model shown in FIG. 5 is composed of a component 10 and a component 20.

Further, a process 11 and a process 12 shown in FIG. 5 are processes in the component 10. Further, a process 21 shown in FIG. 5 is a process in the component 20.

Further, as shown in FIG. 5, a first input is inputted to the process 11. Further, a second input is inputted to the process 12. The first input and the second input are input information indicating the time series of load.

In the specific example, t1 to t3 are functions that return a throughput to the load in the process 11, the process 12, and the process 21, respectively. When the input information indicating the time series of load is inputted, the function t1 and the function t2 return the throughput to the load in the process 11 and the process 12, respectively.

Specifically, when the load of “a first input [a]” that is a first input at a time point a is given to the function t1, the throughput at the time point a in the process 11 is represented by t1 (the first input [a]). Further, t1 (the first input [a]) is a part of the arrival load to the process 21 at the time point a.

Similarly, when the load of “a second input [a]” that is a second input at the time point a is given to the function t2, the throughput at the time point a in the process 12 is represented by t2 (the second input [a]). Further, t2 (the second input [a]) is a part of the arrival load to the process 21 at the time point a.

When the input information indicating the time series of load is inputted, the function t3 returns the throughput to the load in the whole process including the process 11, the process 12, and the process 21. In other words, the throughput at the time point a in the whole process is represented by t3 (t1 (the first input [a]), t2 (the second input [a])).

By taking into account the above-mentioned content, the load function which returns the throughput in the whole process is represented by t3 (t1 (_.1), t2 (_.2)). Where a symbol “_” is the placeholder.

For example, a case is considered in which the function t1 to the function t3 are expressed by the following equations using lambda notation, respectively.

t1=(λx. if x<100 then x else 100) Equation (1)

t2=(λx. if x<100 then x else 100) Equation (2)

t3=(λxy. if x<y then x else y) Equation (3)

Note that a variable in Equation (1) and Equation (2) is x. Equation (1) and Equation (2) mean that t1 and t2 return x if x is smaller than 100, and t1 and t2 return 100 if x is equal to or greater than 100.

Further, the variables in Equation (3) are x and y. Equation (3) means that t3 returns x if x is smaller than y, and t3 returns y if x is equal to or greater than y.

Further, a case is considered in which the predicate representing the required performance inputted to the verification system 100 shown as the specific example is expressed by the following equation.

a=[(½,50),(½,150)],∀x,x∈t(a,a)->moreThan(½,x>50) Equation (4)

Further, “moreThan (½, x>50)” in Equation (4) means that “the probability that x is greater than 50 is greater than ½.” Under the condition described above, for example, the proposition of an object to be proved that is created by the verification unit 102 is expressed by the following equation.

a=[(½,50),(½,150)],∀x1,x1∈(lift(λx′y′. if x′<y′ then x′ else y′)(λx. if x<100 then x else 100)(λx. if x<100 then x else 100))(a,a)->moreThan(½,x1>50) Equation (5)

Further, “lift” in Equation (5) is a function which lifts a function that returns the time series of performance to an input of the time series of load without probability to a function that returns the time series of performance with probability to an input of the time series of load with probability. In other words, “lift” is a kind of function that performs the higher order process. Further, Equation (5) is an equation obtained by substituting each function expressed by Equation (1) to Equation (3) for the function t in Equation (4).

The proof to the proposition expressed by Equation (5) is performed as shown below. First, the simplification is performed to the proposition expressed by Equation (5) as shown by the following equation.

(λx′y′. if x′<y′ then x′ else y′)(λx. if x<100 then x else 100)(λx. if x<100 then x else 100))->(λx. if x<100 then x else 100) Equation (6)

When simplification is performed as shown by the equation (6), the proposition is represented by the following equation.

a=[(½,50),(½,150)],∀x1,x1∈(lift(λx. if x<100 then x else 100))(a,a)->moreThan(½,x1>50) Equation (7)

Next, calculation is performed at each branch destination of the probability in Equation (7) as follows.

a=[(½,50),(½,150)],∀x1,x1∈(lift(λx. if x<100 then x else 100))(a,a)->∀x1,x1∈(lift(λx. if x<100 then x else 100))([(½,50),(½,150)],[(½,50),(½,150)])->[(½,50),(½,100)] Equation (8)

Finally, Equation (8) means that “50 appears at a probability of one-half and 100 appears at a probability of one-half”. Accordingly, “moreThan (½, x1>50)” that is the required performance is satisfied. As described above, it is proved that the proposition expressed by Equation (5) holds.

When the above-mentioned proof is given to the theorem proof assistant tool, the theorem proof assistant tool determines that it is the true proof. In other words, the system that is the object to be tested of the specific example represented by the system model shown in FIG. 5 satisfies the required performance.

The verification system 100 can perform an exhaustive performance test instead of performing a statistical performance test by simulation. This is because the performance required according to a performance objective is represented by the predicate and whereby, it can be confirmed whether or not the proof is true in the exhaustive performance test by the theorem proof assistant tool.

For example, the verification unit 102 of the verification system 100 establishes a model which integrates performance values to all the probability branches by using type information in a programming language. When the model which integrates the performance values is established, an existing theorem proof assistant tool can exhaustively test whether or not the required performance represented by the predicate in predicate logic is satisfied.

Further, it is not necessary for the designer using the verification system 100 to have a mathematical knowledge required for describing the mathematical model that is a model of the verification object. This is because the model conversion unit 101 of the verification system 100 can create the mathematical model representing the system on the basis of the activity diagram representing the system of the design object.

For example, the model conversion unit 101 of the verification system 100 creates the mathematical model on the basis of the activity diagram which is described in the UML (Unified Modeling Language) that is an annotation language generally used for design and to which a load comment is given. Accordingly, even if the designer does not prepare knowledge related to the mathematical model, the designer can establish the model required for test.

Further, for example, the verification system 100 is realized by a Central Processing Unit (CPU) which executes a process according to a program stored in a storage medium. In other words, for example, the model conversion unit 101, the verification unit 102, and the event description conversion unit 103 are realized by the CPU which executes the process according to program control.

Alternatively, each unit in the verification system 100 may be realized by a hardware circuit. As an example, the model conversion unit 101, the verification unit 102, and the event description conversion unit 103 are realized by Large Scale Integrations (LSIs), respectively. Further, these units may alternatively be realized by one LSI.

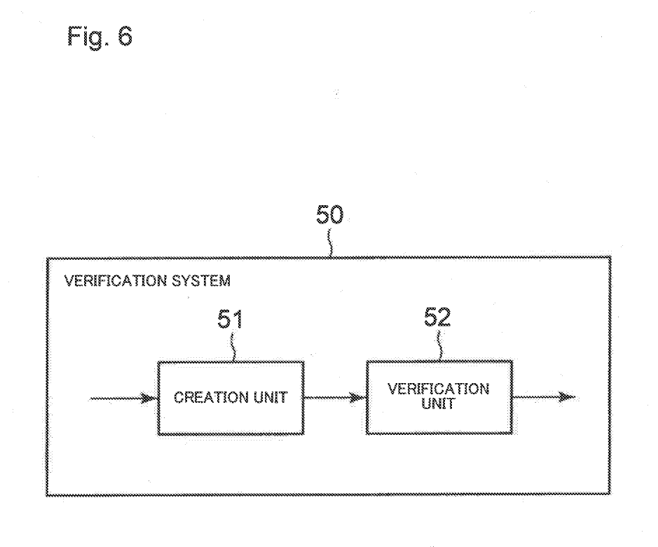

Next, a summary of the present invention will be described. FIG. 6 is a block diagram illustrating an outline of a verification system of the present invention. A verification system 50 includes a creation unit 51 (for example, the verification unit 102) to which a mathematical model obtained by converting a model indicating a configuration of a test object system into the predicate in predicate logic is inputted and which creates the proposition indicating that the test object system satisfies the performance requirement represented by the predicate and a verification unit 52 (for example, the verification unit 102) which verifies whether or not the proof of the created proposition is true.

By such configuration, the verification system can mathematically prove that the system performance is guaranteed with respect to probabilities of loads that arrive.

Further, the verification system 50 may include a model conversion unit (for example, the model conversion unit 101) which converts a model indicating the configuration of the test object system into the mathematical model.

By such configuration, the verification system can save the designer the trouble of learning mathematical knowledge.

Further, the creation unit 51 may input the mathematical model to the predicate with which the time series of the probability of load on the test object system is combined.

By such configuration, the verification system can mathematically prove that whether or not the system performance is guaranteed by using the predicate with which the time series of probabilities of loads that arrive is combined.

Further, the verification system 50 may include an event conversion unit (for example, the event description conversion unit 103) which converts information indicating a load event into the time series of the probability of load on the test object system and the creation unit 51 may input the mathematical model to the predicate with which the converted time series is combined.

By such configuration, the verification system can mathematically prove that whether or not the system performance is guaranteed to the load event that occurs.

Further, the time series of the probability of load on the test object system may be a time series created on the basis of a predetermined probability distribution.

By such configuration, the verification system can mathematically prove that whether or not the system performance is guaranteed by using the predicate of which the probability distributions related to the probabilities of loads that arrive is taken into consideration.

Further, the model indicating the configuration of the test object system may be a model described in the activity diagram or a model described in the markup language.

By such configuration, the verification system can use a model which can be easily described by the designer as the object to be processed.

Further, the performance requirement may be represented by the predicate in higher-order predicate logic.

By such configuration, the verification system can verify whether or not the proof that the test object system satisfies a more complicated performance requirement is true.

Further, the verification unit 52 may verify whether or not the proof of the proposition is true by using the theorem proof assistant tool.

By such configuration, the verification system can verify whether or not the proof is true by using an existing theorem proof assistant tool.

Further, the creation unit 51 may perform the higher order process with respect to probability to the mathematical model.

By such configuration, the verification system can use the mathematical model to which the time series of load is inputted as the object to be processed.

The present invention is suitably applied to the exhaustive performance test to a system in which a load variation caused by environment change is large.

Further, the direction of the arrow in the drawing shows the signal flow direction as an example. Therefore, the signal flow direction between the blocks is not limited to the direction of the arrow shown in the drawing.

The present invention has been described above with reference to the example embodiment described as an exemplary embodiment. However, the present invention is not limited to the example embodiment described above. In other words, various embodiments that can be understood by those skilled in the art can be applied without departing from the scope of the present invention.

This application claims priority from Japanese Patent Application No. 2016-090233, filed on Apr. 28, 2016, the disclosure of which is hereby incorporated by reference in its entirety.

### REFERENCE SIGNS LIST

10, 20 component
11, 12, 21 process
50, 100 verification system
51 creation unit
52, 102 verification unit
101 model conversion unit
103 event description conversion unit

What is claimed is:

1. A verification system comprising:
at least one memory configured to store instructions; and
at least one processor configured to execute the instructions to:
receive, as input, a mathematical model obtained by converting a model indicating a configuration of a test object system into a predicate in predicate logic and create a proposition indicating that the test object system satisfies a performance requirement represented by the predicate; and
verify whether or not a proof of the proposition having been created is true.

2. The verification system described in claim 1, further comprising:
the at least one processor further configured to execute the instructions to
convert a model indicating a configuration of a test object system into a mathematical model.

3. The verification system described in claim 1,
the at least one processor further configured to execute the instructions to:
input the mathematical model to the predicate with which a time series of probabilities of loads on the test object system is combined.

4. The verification system described in claim 3,
the at least one processor further configured to execute the instructions to:
convert information indicating a load event into a time series of probabilities of loads on the test object system, and
input the mathematical model to the predicate with which the time series having been converted is combined.

5. The verification system described in claim 1 wherein the model indicating the configuration of the test object system is a model described in an activity diagram or a model described in a markup language.

6. The verification system described in claim 1 wherein the performance requirement is represented by the predicate in higher-order predicate logic.

7. A verification method comprising:
inputting a mathematical model obtained by converting a model indicating a configuration of a test object system into a predicate in predicate logic and creating a proposition indicating that the test object system satisfies a performance requirement represented by the predicate; and
verifying whether or not a proof of the proposition having been created is true.

8. The verification method described in claim 7, further comprising:
converting a model indicating a configuration of a test object system into a mathematical model.

9. A non-transitory computer readable recording medium storing a verification program which causes a computer to
input a mathematical model obtained by converting a model indicating a configuration of a test object system into a predicate in predicate logic,
create a proposition indicating that the test object system satisfies a performance requirement represented by the predicate, and
verify whether or not a proof of the proposition having been created is true.

10. The recording medium storing a verification program described in claim 9 which causes the computer to further perform a conversion process for converting a model indicating a configuration of a test object system into a mathematical model.
